(19) United States
(12) Patent Application Publication
(10) Pub. No.: US 2007/0288207 A1
(43) Pub. Date: Dec. 13, 2007

(54) Displaying characteristics of a system of interconnected components at different system locations

(75) Inventors: Thord Allan Backe, Hopkinton, NH (US); Xinsheng Cheng, Manchester, NH (US); Jorgen Dahl, Merrimack, NH (US); Jason Martin, Pembroke, NH (US)

Correspondence Address: PATTERSON & SHERIDAN, L.L.P., 3040 POST OAK BOULEVARD, SUITE 1500, HOUSTON, TX, 77056, US

(73) Assignee: Autodesk, Inc.

(21) Appl. No.: 11/451,924

(22) Filed: Jun. 12, 2006

(51) Int. Cl. G06F 17/50

(52) U.S. Cl. 703/1

(57) ABSTRACT

A combined computer-aided design (CAD) and analysis program includes a system inspector feature in a graphical user interface (GUI) that allows designers to identify a critical path among interconnected sets of components within a piping or a heating, ventilation, and air-conditioning (HVAC) system and provides pressure characteristics of the elements. This program provides visual feedback in an iterative design process.

### BACKGROUND OF THE INVENTION

1. Field of the Invention

The present invention generally relates to computer graphics and applications, graphical user interfaces, and computer simulation and modeling. More specifically, the present invention relates to a computer-aided design (CAD) system for displaying characteristics of a system of interconnected components at different system locations.

2. Description of the Related Art

The term computer-aided design (CAD) generally refers to a broad variety of computer-based design tools used by architects, engineers, and other construction and design professionals. CAD systems allow users to create, manage, and share design data with integrated design and data management tools. Some CAD systems allow users to construct 3D models representing virtually any real-world construct, such as homes, offices, and other buildings. These CAD systems typically generate a variety of 2D and 3D views on a computer display, such as plan, profile, section, and elevation views.

Traditionally, two separate programs have been used for the design and analysis of system designs. The first is a CAD system design program (for laying out building engineering systems) and construction documentation (for producing coordinated construction documents) for architects, structural engineers, and others. The second is an analysis program provided engineering data (for calculation, analysis, and sharing) for mechanical, electrical, and plumbing (MEP) engineers. Typically, a user develops a preliminary design on the CAD system. Then, the user transfers characteristics of the design from the CAD system to a separate analysis program to calculate engineering data, such as identifying flow rates and critical path segments of a system. The user then generates a new design using the calculated engineering data. Many subsequent iterations of design and analysis typically follow, until satisfactory cost, and efficiency constraints are achieved.

Design characteristics and engineering data include various kinds of information related to building design and construction, including mechanical duct and pipe systems models, electrical lighting and power circuitry, electrical lighting calculations, plumbing system models, building support, structure support, and heating, ventilation, and air-conditioning (HVAC) energy and load analysis, and the like. In the iterative development of piping and/or HVAC systems, transferring characteristics of the design as input to the analysis program to calculate engineering data and, then, transferring calculated engineering data into a design program to generate a new design is a time-consuming and error-prone process. Much time may be lost refining a system design or updating numerous design characteristics and engineering data. An engineer or draftsperson typically wastes time performing tedious updating tasks and sometimes makes costly errors. For piping and/or HVAC systems, manual tasks might include identifying flow rates and critical path segments for a piping system, for example.

Accordingly, design and construction professionals need a CAD system that provides combined design and analysis to eliminate the time that is currently spent manually transferring and entering data between separate design and analysis program in an iterative process. This would minimize tedious updating tasks and costly errors and improve productivity, accuracy, and coordination between design and construction teams.

### SUMMARY OF THE INVENTION

The present invention is directed to methods and computer program products that minimize tedious updating tasks and costly errors, and improve productivity, accuracy, and coordination between design and construction teams by displaying characteristics of a system of interconnected components at different system locations.

One embodiment of the invention is a method for displaying characteristics of a system of interconnected components at different system locations. The CAD system detects a location of a pointing device, calculates a characteristic of the system at the detected location, and displays the calculated characteristic of the system. The calculated characteristic may be a critical path among the interconnected components. The displayed characteristics may include a flow rate or a pressure loss. The CAD system may display an updated calculated characteristic of the system in response to receiving a change to the system of interconnected components. In one embodiment, the interconnected components comprise a set of components. The change may comprise splitting one of the sets of components into two or more sets or joining two or more sets of components into one set. One set may comprise components with one or more common transmission parameters.

Another embodiment of the invention is a computer-readable medium containing a program which when executed by a processor, performs the above method.

Another embodiment of the invention is a method for interacting with a display of interconnected components. The user positions a pointing device over a first position to cause a display of a first characteristic of the interconnected components at the first position. The user positions a pointing device over a second position to cause a display of a second characteristic of the interconnected components at the second position. The first characteristic of the system may be a critical path among the interconnected components. The second characteristic may be a flow rate. The user may also make a change to the interconnected components to cause a display of an updated calculated characteristic of the system.

Advantageously, by displaying characteristics of a system of interconnected components at different system locations, the CAD system eliminates the time users currently spend manually transferring and entering data between separate design and analysis program in an iterative process. This minimizes tedious updating tasks and costly errors and improves productivity, accuracy, and coordination between design and construction teams.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only exemplary embodiments of this invention and are therefore not to be considered limiting of its scope, for the claimed invention may admit to other equally effective embodiments.

FIG. 1 is a 3D view of an exemplary ductwork system generated in accordance with an embodiment of the present invention.

FIG. 2 is a 3D view that illustrates supply and return subsystems of the exemplary ductwork system of FIG. 1.

FIG. 3 is a 3D view that illustrates analysis information for a component of the exemplary ductwork system of FIG. 1.

FIG. 4 is a 3D view that illustrates analysis information for the exemplary ductwork system of FIG. 1.

FIG. 5 is a 3D view that illustrates how the exemplary ductwork system of FIG. 1 is divided into sections.

FIG. 6 is a 3D view that illustrates sections of the exemplary ductwork system of FIG. 1.

FIG. 7 is a 3D view that illustrates a critical path of the exemplary ductwork system of FIG. 1.

FIGS. 8A and 8B show a graphical user interface for changing the size of one or more ducts in the exemplary ductwork system of FIG. 1 according to one embodiment of the present invention.

FIG. 9 is a 3D view that illustrates resulting analysis information in response to the change shown in FIGS. 8A and 8B to the exemplary ductwork system of FIG. 1.

FIGS. 10-13 illustrate how a change to the exemplary ductwork system of FIG. 1 results in the splitting of a section into two or more sections.

FIG. 14 is a block diagram of a networked computer environment in which systems and methods according to embodiments of the present invention may be implemented.

FIG. 15 is a flow chart of an exemplary method of displaying characteristics of a system of interconnected components at different system locations according to one embodiment of the present invention.

### DETAILED DESCRIPTION OF THE PREFERRED EMBODIMENTS

One exemplary embodiment is a CAD system that displays characteristics of a system of interconnected components at different system locations. The CAD system includes a combined design and analysis program. The present invention applies to a broad variety of design and analysis features beyond those incidentally described herein. Although the detailed description describes the CAD system in the context of an exemplary ductwork system, the present invention applies to representations of virtually any real-world construct, such as electrical, mechanical, architectural, or structural elements, or and other kind of design or construction elements for homes, offices, and other buildings or structures.

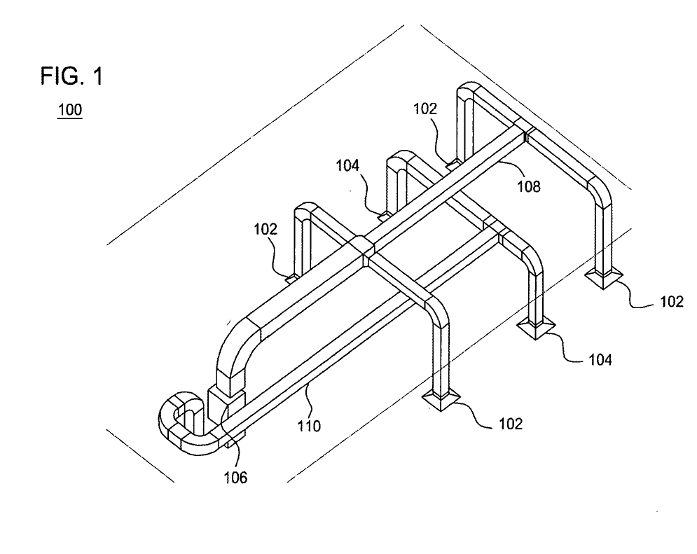

FIG. 1 is a 3D view 100 of an exemplary ductwork system that has been generated in accordance with an embodiment of the present invention. In this example, the ductwork system includes supply terminals 102, return diffusers 104, an air-handling unit 106, and network of ducts 108, 110. Four supply terminals 102 are connected with a first network of ductwork 108 to an air-handling unit 106. Two return diffusers 104 are connected with a second network of ductwork 110 to the air-handling unit 106. A CAD system displays 3D view 100 and provides combined design and analysis. FIG. 1 illustrates the design aspect of the CAD system, which includes displaying 3D connectivity information, among many other design features.

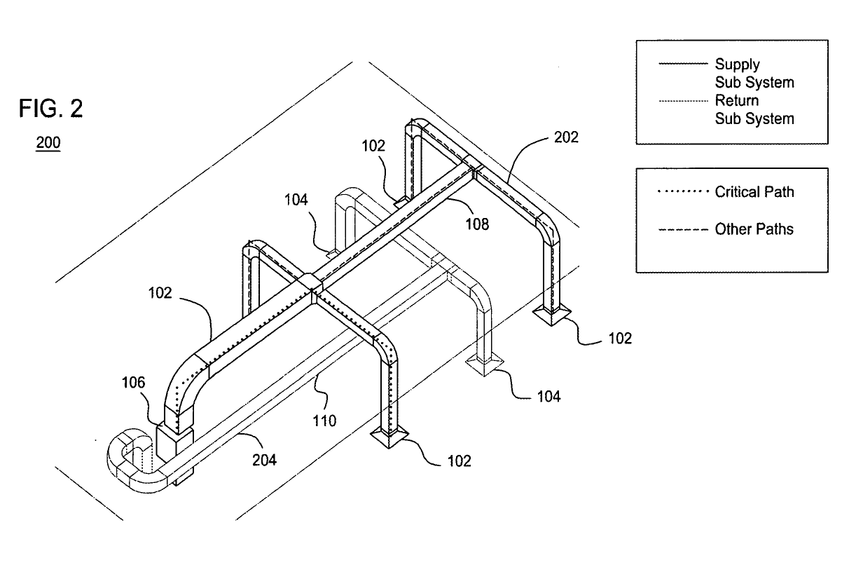

FIG. 2 is a 3D view 200 of the exemplary ductwork system of FIG. 1 that has been generated in accordance with an embodiment of the present invention. FIG. 2 highlights the difference between the supply subsystem 202 and the return subsystem 204. The supply subsystem 202 includes the supply terminals 102 and the first network of ductwork 108, while the return subsystem includes the return diffusers 104, the second network of ductwork 110. The air-handling unit 106 is a member of both the supply and return systems. The user may select a subsystem to analyze. In FIG. 2, the supply subsystem 202 has been selected for analysis and is displayed in a visibly different way than the inactive return subsystem, which was not selected for analysis. Other embodiments may display active subsystems in different ways.

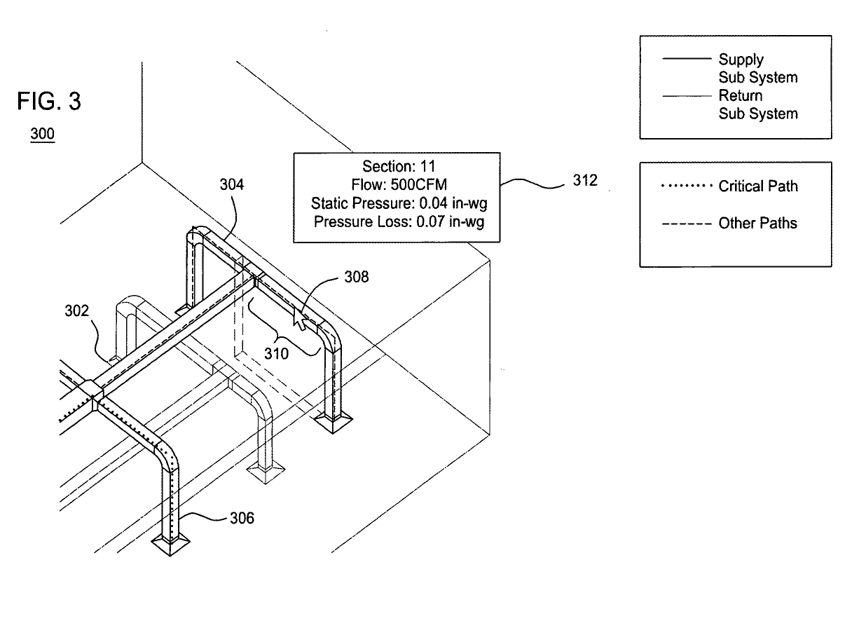

FIG. 3 is a 3D view 300 of the exemplary ductwork system of FIG. 1 that has been generated in accordance with an embodiment of the present invention. FIG. 3 shows some analysis information. The CAD system provides combined design and analysis. As part of the analysis, the CAD system provides a system inspector feature in a graphical user interface (GUI), which may be implemented in a software application or software module. The user may enable or disable the system inspector using the GUI. The system inspector performs analysis information (e.g., flow and data calculations) for a system (e.g., the exemplary ductwork system) or a subsystem (e.g., the supply 202 or return 204 subsystem). For example, the system inspector may calculate a critical path. The critical path is the path through the system or subsystem that has the most pressure losses. Pressure losses may vary depending on the length of the path, airflow, size of ducts, and anything that causes additional airflow friction. The critical path is the path through the system that consumes the most energy. As a result, a designer often attempts to generate a new design that is more efficient and lower cost. The CAD system facilitates an iterative design and analysis process, among other uses.

FIG. 3 shows part of the critical path 306 in a dotted line and other paths 302, 304, 308 in dashed lines. In one embodiment, the critical path is displayed in red, while the other paths are displayed in blue. Other embodiments may display these paths in various other ways, such as shading components. In a preferred embodiment, the critical path and other paths are displayed continuously, when the system inspector is enabled. Other embodiments may display the paths differently, such as only when the user positions a pointing device near a system component. When the user positions a pointing device 308 (e.g., mouse, trackball, or any device capable of moving the cursor on the display) over a component 310 of the supply subsystem, the system inspector provides additional analysis information 312 for display near the component 310. In other embodiments, a user may view analysis information for a component in various other ways, such as in a separate window. As shown in FIG. 3, the analysis information 312 includes a section number of 11, a flow rate of 500 cubic feet per minute (cfm), a static pressure of 0.04 inch water gauge (in-wg), and a pressure loss of 0.07 in-wg. Other embodiments may provide different information suitable to the type of system under analysis.

Each supply terminal 102 (FIG. 1) is associated with a quantity of airflow to be provided to a room. The CAD system propagates this information throughout the interconnected components of the duct system. The system inspector divides the system into a number of sections by analyzing all the components of the system and their interconnections and numbers the sections. A section is a collection of connected elements that share one or more characteristics or properties, such as flow rate, friction, or size. Other embodiments may designate sections differently, such as with letters or names. In one embodiment, the system inspector may number the sections sequentially or order the sections by some property or characteristic.

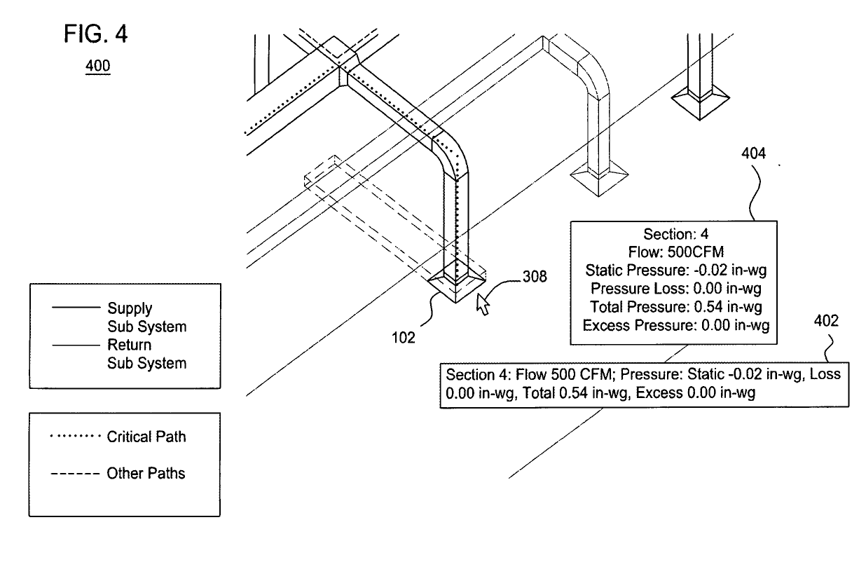

FIG. 4 is a 3D view 400 of the exemplary ductwork system of FIG. 1. FIG. 4 illustrates additional analysis information. When the user positions the pointing device 308 over or near a supply terminal 102, the CAD system displays two lists of information. A brief section identification list 402 and a more lengthy engineering data list 404. In one embodiment, the section identification list 402 is displayed for a limited time period, while the engineering data list 404 is displayed so long as the pointing device is near the component. The present invention is not limited to any particular kind or amount of engineering data and may include any data related to the system being analyzed. The present invention is also not limited to any particular kind or amount of information in the section identification list so long as it identifies a section in some way. For example, the section identification may be in graphical form rather than textual form. Engineering data may also be in graphical or other forms.

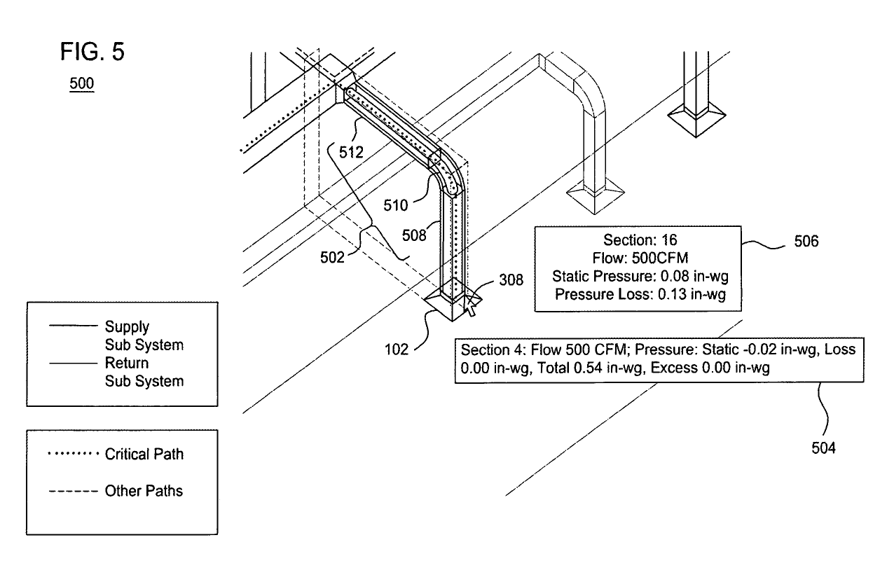

FIG. 5 is a 3D view 500 of the exemplary ductwork system of FIG. 1 that has been generated in accordance with an embodiment of the present invention. FIGS. 4 and 5 illustrate the system inspector dividing the supply terminal 102 and the connected duct network 502 into different sections (i.e., section 4 in FIG. 4 and section 16 in FIG. 5 respectively), even though the components 102, 502 are adjacent to one another. In FIG. 5, duct network 502 is in section 16, which includes three components, a vertical duct 508, an elbow 510, and a horizontal duct 512. The user may move the pointing device quickly over different components, checking the brief section identification list 504 to see how the system inspector has divided the system into sections. The user may use the engineering data list 506 for revising the design or for other purposes.

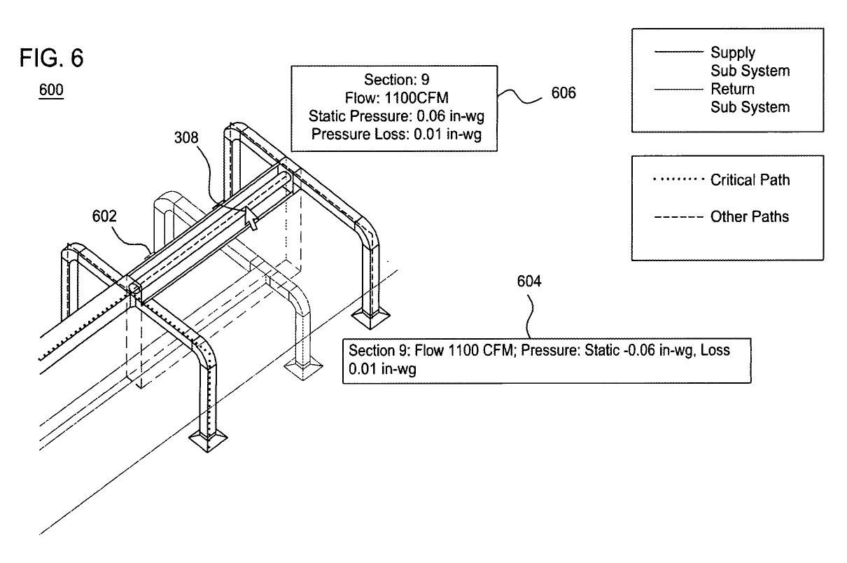

FIG. 6 is a 3D view 600 of the exemplary ductwork system of FIG. 1 that has been generated in accordance with an embodiment of the present invention. FIGS. 4-6 illustrate that different sections (i.e., sections 4, 16, and 9) have at least one different characteristic, such as pressure loss (i.e., 0.00, 0.12, and 0.01 in-wg), even though the components (i.e., supply terminal 102, vertical duct 502, and horizontal duct 602) are connected and adjacent. Typically, there are different sections on each side of a “T” location, because the flow changes (i.e., 500 cmf to 1100 cfm from section 16 to section 9).

FIG. 6 shows a third section (i.e., section 9). FIG. 6 illustrates that when the user moves the pointing device over or near a section, all of the components in the section are visually distinguished. In FIG. 6, the user positioned the pointing device 308 near the horizontal duct 602, causes the CAD system to display a section identification list 604 and an engineering data list 606. In addition, the CAD system makes the horizontal duct 602 visually distinct by increasing the line thickness of the horizontal duct 602, because section 9 contains this one component. By contrast, section 16 (shown in FIG. 5) contains three components, i.e., the duct network 502 includes vertical duct 508, elbow 510 and horizontal duct 512. The duct network 502 is also visually distinct. Other embodiments may make components in a section visually distinct in various ways, such as using shading, color, textual information, and the like. In one embodiment, every component in a system may be visually distinct at the same time.

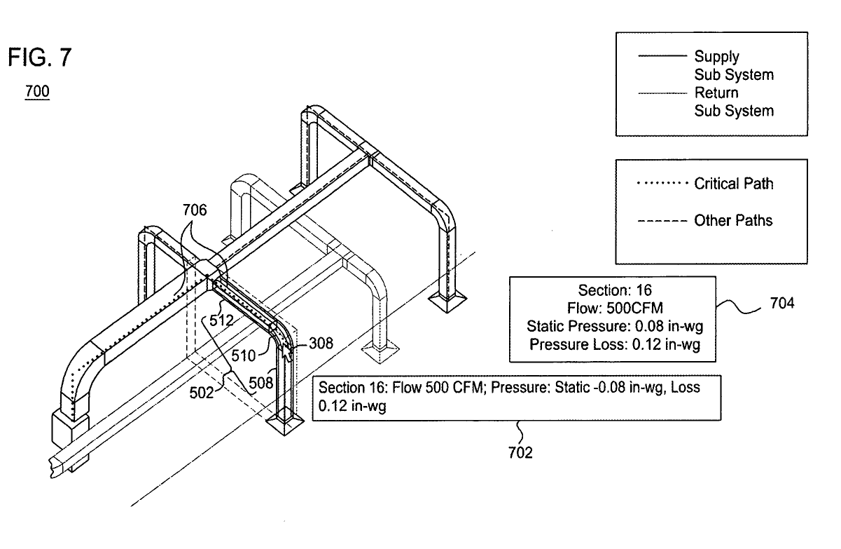

FIG. 7 is a 3D view 700 of the exemplary ductwork system of FIG. 1 that has been generated in accordance with an embodiment of the present invention. FIG. 7 shows a critical path 706 that is not the longest path through the ductwork system. When the user moves the pointing device 308 near the components in one of the sections along the critical path to investigate, the CAD system displays a section identification list 702 and an engineering data list 704 for section 16, which contains three interconnected components 508, 510, 512. The engineering data list 704 indicates that there is a large loss, i.e., 0.12 in-wg in section 16.

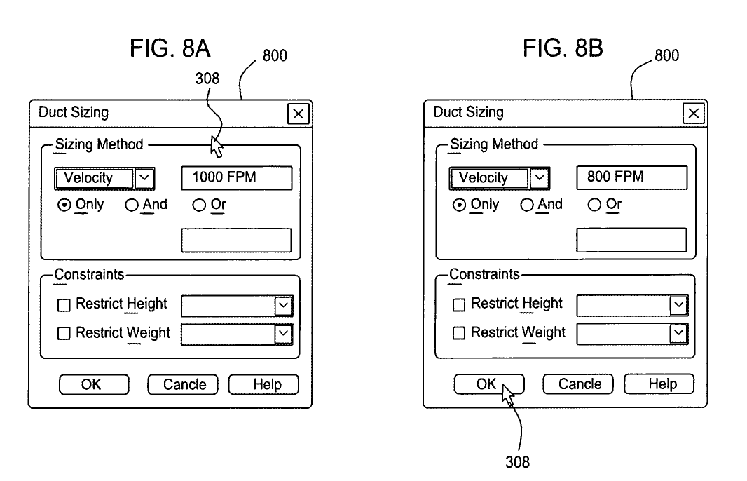

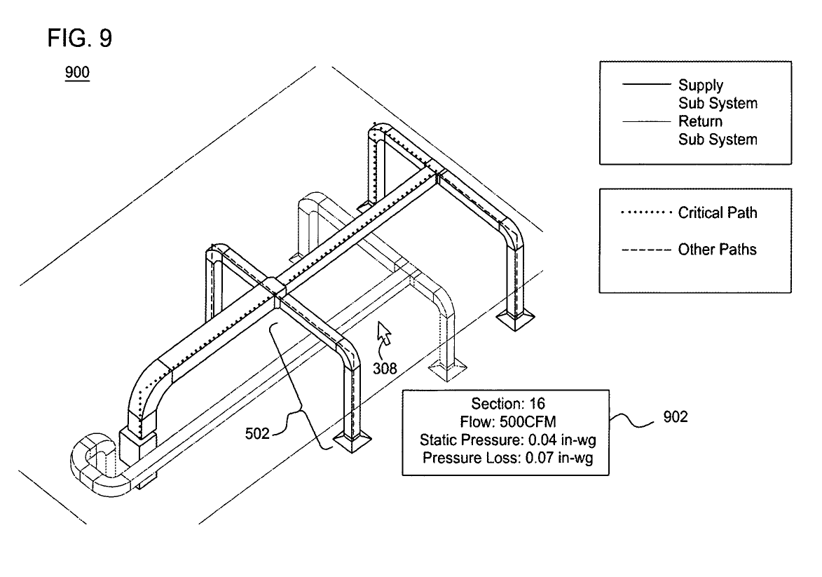

FIGS. 8A and 8B show a graphical user interface 800 for changing the size of one or more ducts that has been generated in accordance with an embodiment of the present invention. FIG. 8A illustrates that the CAD system includes different sizing methods and that the current size of the duct network 502 in section 16 is the size required for a velocity of 1,000 feet per minute (fpm). FIG. 8B illustrates the user changes the size by changing the required velocity to 800 fpm, attempting to reduce the loss in section 16 and, as a result, change the critical path. FIGS. 8A and 8B illustrate one way the user may perform both design and analysis at the same time using the CAD system. Other embodiments include changes to other properties or characteristics, such as changing the shape or size of a duct or other changes in design, such as adding (or removing) a component to (or from) the system. FIG. 9 illustrates the results of the change.

FIG. 9 is a 3D view 900 of the exemplary ductwork system of FIG. 1 that has been generated in accordance with an embodiment of the present invention. As shown in FIG. 9, the duct network 502 is no longer along the critical path. Engineering data list 902 for section 19 containing the duct network 502 now indicates that the pressure loss is 0.07 in-wg. In FIG. 9, the CAD system provides the user with feedback, e.g., analysis data changes in response to the design change. Traditionally, two separate programs have been used for the design and analysis of system designs. Thus, embodiments of the present invention minimize tedious updating tasks and costly errors and improve productivity, accuracy, and coordination between design and construction teams by displaying characteristics of a system of interconnected components at different system locations.

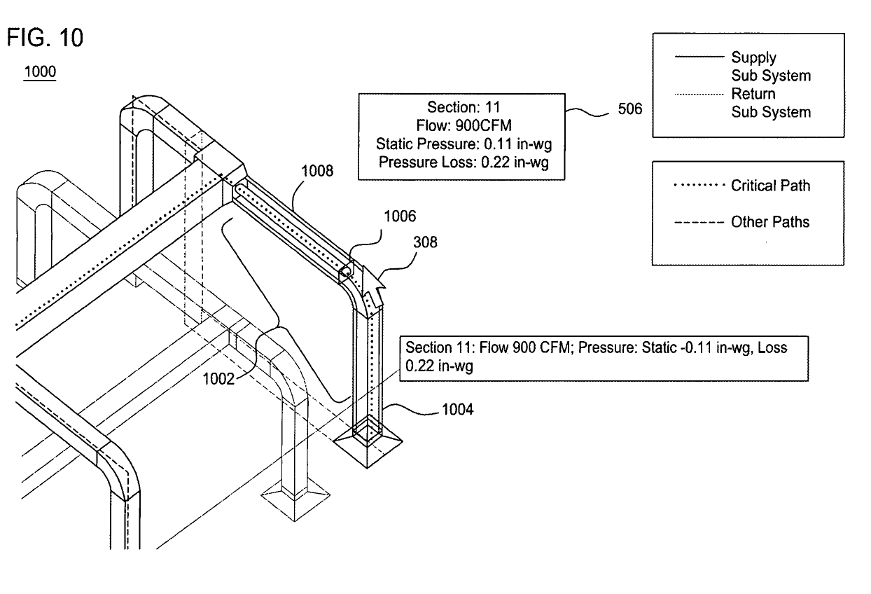

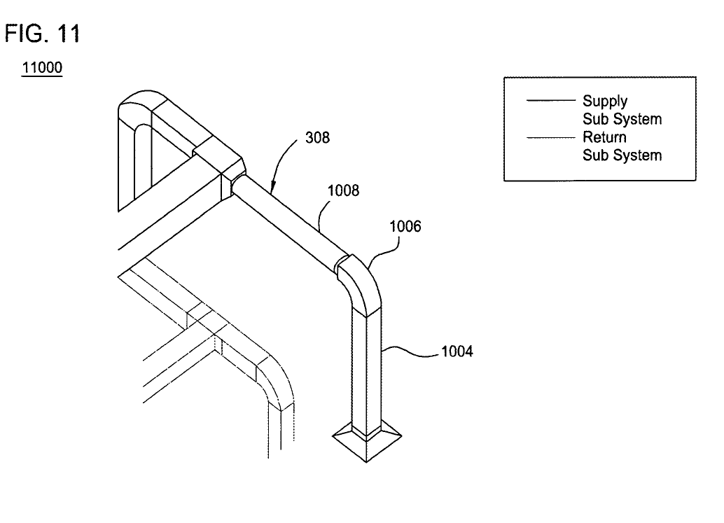

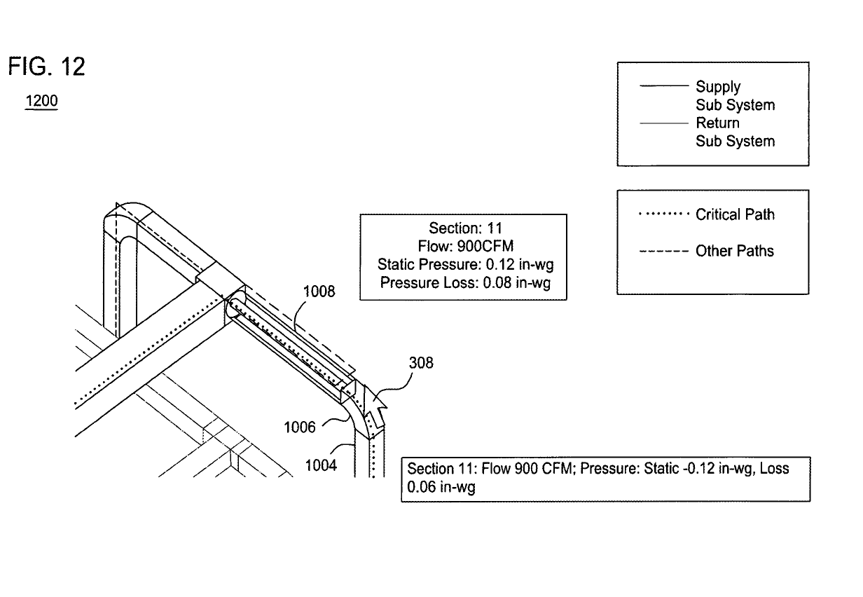

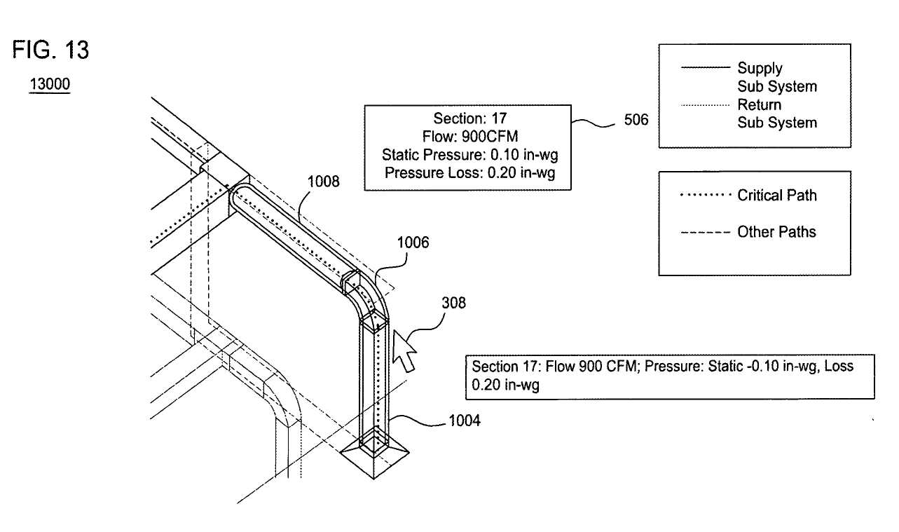

FIGS. 10-13 illustrate how a change to the system results in the system inspector splitting a section into two or more sections. FIGS. 10-13 are 3D views 1000, 1100, 1200, 1300 of the exemplary ductwork system of FIG. 1 that has been generated in accordance with an embodiment of the present invention. Duct network 1002 contains three system components: vertical duct 1004, elbow 1006, and horizontal duct 1008. Section 11 contains these three components. FIG. 11 illustrates the components after the user made a change to the shape of horizontal duct 1008, i.e., from rectangular to circular. FIGS. 12 and 13 illustrate that section 11 now contains only horizontal duct 1008 while new section 17 contains elbow 1006 and vertical duct 1004. The system inspector splits section 11 into two sections, i.e., new section 11 and section 17. Similarly, a change to the system may result in the system inspector joining two or more sections into one section.

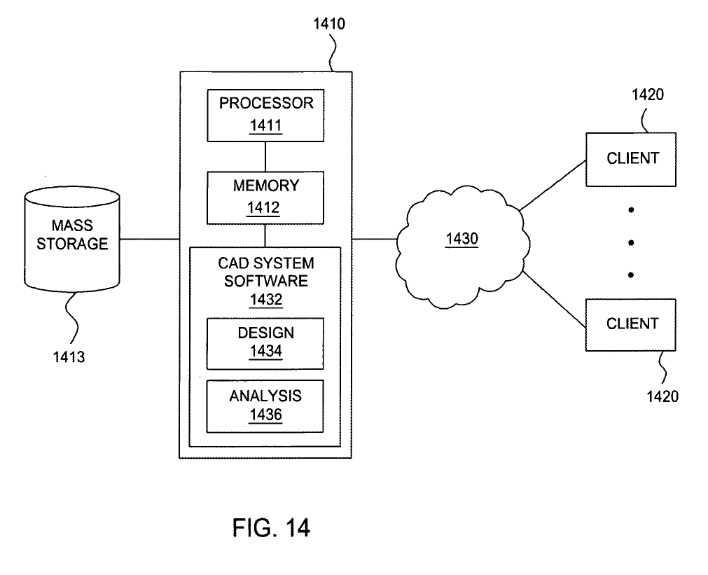

FIG. 14 is a block diagram of a computer environment 1400 in which systems and methods according to embodiments of the present invention may be implemented. One embodiment of the computer environment 1400 includes a computer 1410 (e.g., personal computer (PC)) programmed as a standalone, single workstation operating the CAD system and having conventional output devices, such as a computer display or a printer for generating the annotation graphics in 2D form. The CAD system software 1432, which runs on the processor 1411, includes both a design component 1434 and an analysis component 1436. Traditionally, two separate programs have been used for the design and analysis of system designs. By contrast, embodiments of the present invention eliminate the time that is currently spent manually transferring and entering data between separate design and analysis program in an iterative process. This minimizes tedious updating tasks and costly errors and improves productivity, accuracy, and coordination between design and construction teams.

Another embodiment of the computer environment 1400 includes a server computer 1410 and a number of client computers 1420 (only two of which are shown). A computer network 1430 (e.g., a local area network (LAN)) connects the server computer 1410 and the client computers 1420. The components of the server computer 1410 that are illustrated in FIG. 14 include a processor 1411 and a system memory 1412. The server computer 1410 is connected to a mass storage unit 1413 that stores the contents managed by the server computer 1410. Each client computer 1420 includes conventional components of a computing device, e.g., a processor, system memory, a hard disk drive, input devices, such as a mouse and a keyboard, and output devices, such as a monitor (not shown). The server computer 1410 is programmed to operate as a network server that communicates with the client computers 1420.

In another embodiment, the server computer 1410 is programmed as a web server that communicates with the client computers 1420 using the TCP/IP protocol, and hosts a web site that can be accessed by the client computers 1420. The client computers 1420 are programmed to execute client programs to access the CAD system as a service provided by the server computer 1410. The server computer 1410 manages the content stored in the mass storage unit 1413 using a database management system. The contents include elements of CAD drawings, designs, 3D models, and 2D views, analytical models, engineering data, such as fluid flow, and other data.

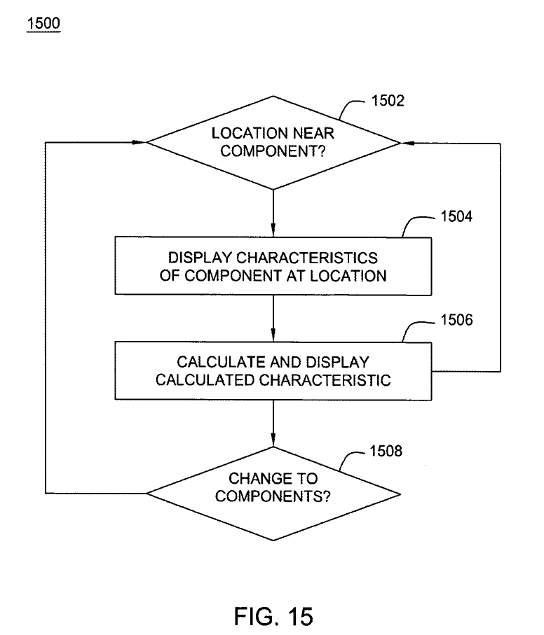

FIG. 15 is a flow chart of an exemplary method 1500 of displaying characteristics of a system of interconnected components at different system locations according to one embodiment of the present invention. At 1502, the CAD system detects a location of a pointing device. At 1504, the CAD system displays characteristics (e.g., flow rate or a loss) of a component at the location. At 1506, the CAD system calculates and displays a characteristic (e.g., critical path) of the system. At 1508, the CAD system detects a change to the components and displays updated characteristics by repeating steps 1502-1508. Other embodiments may perform the steps in a different order or perform additional steps. FIG. 15 illustrates how the CAD system incorporates both design (step 1508) and analysis (steps 1504 and 1506) and facilitates an iterative process of design and analysis in a single CAD system.

While particular embodiments according to the invention have been illustrated and described above, those skilled in the art understand that the invention can take a variety of forms and embodiments within the scope of the appended claims.

What is claimed is:

1. A method for displaying characteristics of a system of interconnected components at different system locations, comprising:
detecting a location of a pointing device;
calculating a characteristic of the system at the detected location; and
displaying the calculated characteristic of the system.

2. The method of claim 1, wherein the calculated characteristic of the system is a critical path among the interconnected components.

3. The method of claim 1, wherein the characteristics comprises a flow rate.

4. The method of claim 1, wherein the characteristics comprises a loss.

5. The method of claim 1, further comprising:
displaying an updated calculated characteristic of the system in response to receiving a change to the system of interconnected components.

6. The method of claim 5, wherein the interconnected components comprise a set of components and the change comprises splitting one of the sets of components into at least two sets.

7. The method of claim 5, wherein the interconnected components comprise a set of components and the change comprises joining at least two sets of components into one set.

8. The method of claim 5, wherein the interconnected components comprise a set of components and one set comprises components with at least one common transmission parameter.

9. A computer-readable medium containing a program which when executed by a processor, performs a method for displaying characteristics of a system of interconnected components at different system locations, the method comprising:
detecting a location of a pointing device;
calculating a characteristic of the system at the detected location; and
displaying the calculated characteristic of the system.

10. The method of claim 9, wherein the calculated characteristic of the system is a critical path among the interconnected components.

11. The method of claim 9, wherein the characteristics comprises a flow rate.

12. The method of claim 9, wherein the characteristics comprises a loss.

13. The method of claim 9, further comprising:
displaying an updated calculated characteristic of the system in response to receiving a change to the system of interconnected components.

14. The method of claim 13, wherein the interconnected components comprise a set of components and the change comprises splitting one of the sets of components into at least two sets.

15. The method of claim 13, wherein the interconnected components comprise a set of components and the change comprises joining at least two sets of components into one set.

16. The method of claim 13, wherein the interconnected components comprise a set of components and one set comprises components with at least one common transmission parameter.

17. A method for interacting with a display of interconnected components, comprising:
positioning a pointing device over a first position to cause a display of a first characteristic of the interconnected components at the first position; and
positioning a pointing device over a second position to cause a display of a second characteristic of the interconnected components at the second position.

18. The method of claim 17, wherein the first characteristic of the system is a critical path among the interconnected components.

19. The method of claim 17, wherein the second characteristic comprises a flow rate.

20. The method of claim 17, further comprising:
making a change to the interconnected components to cause a display of an updated calculated characteristic of the system.
